(19) United States
(12) Patent Application Publication
(10) Pub. No.: US 2008/0293023 A1
(43) Pub. Date: Nov. 27, 2008

(54) Sports instruction system and method

(76) Inventors: Glen M. Diehl, Lebanon, NJ (US); John F. Lynch, Summit, NJ (US); Daniel Bastone, Miami Beach, FL (US)

Correspondence Address: Glen M. Diehl, 22 Old Mine Road, Lebanon, NJ, 08833, US

(21) Appl. No.: 11/807,222

(22) Filed: May 26, 2007

(51) Int. Cl. G09B 19/00

(52) U.S. Cl. 434/248; 434/247; 434/249; 434/250; 434/251; 434/252; 434/253; 434/254; 434/255

(57) ABSTRACT

Systems and methods of providing sports instruction are disclosed. In accordance with one aspect of the invention, the method includes the steps of each of a plurality of instructors entering a name and one or more credentials into a server based data storage unit and each of the plurality of students selecting one of the plurality of instructors based on the one or more credentials. At a server, one or more uploaded files are received from each of the plurality of students and they are stored in the data storage unit. A selected one of the plurality of instructors reviews the uploaded files and provides instruction based on the uploaded files. The students can rate the instructors based on their experience. Other aspects of online sports instruction are also disclosed.

### BACKGROUND OF THE INVENTION

One aspect of the present invention relates to sports instruction, including systems and methods of providing sports instruction. By way of example, it relates to methods and systems that allow students and instructors in one or more sports to meet, interact and transact on a ubiquitous peer-to-peer network.

It is very difficult to become an accomplished athlete in any sport. It takes a great deal of practice. It also takes good instruction from an accomplished instructor. Unfortunately, it is very difficult to find a good instructor or an instructor that a student connects with. It is also difficult for instructors to find students. It is also difficult for instructors and students to schedule time and location for instruction to occur.

Even when a student finds a good instructor, the instruction is very expensive. When the amount of instruction required to get good is considered, the instruction is very expensive. Often the cost is too prohibitive and good athletes are forced to go without the instruction needed to reach full potential. One of the costs in providing instruction is associated with infrastructure needed to provide instruction. Instructors and students must pay significant amounts of their fees to use the infrastructure, thereby increasing the costs of the lessons.

In short, it is very difficult for students of a sport to connect with an instructor so that the student can reach their full potential. In addition, many capable instructors are not instructing due to the difficulties of finding students and scheduling time. This connection is particularly difficult to achieve in many of the less popular sports. Accordingly, a new system and method for sports instruction is needed.

### SUMMARY OF THE INVENTION

The present invention provides systems and methods of providing online sports instruction. In accordance with one aspect of a system in accordance with the present invention, the system provides instruction in a sport over the internet. The system includes a data storage unit that stores information relating to a plurality of instructors in the sport and to a plurality of students in the sport, a first data entry screen used by the plurality of instructors, wherein each of the plurality of instructors can enter a name and one or more credentials into the data storage unit and a second data entry screen used by the plurality of students to select one of the plurality of instructors based on the one or more credentials. The system also includes means for receiving one or more uploaded files from each of the plurality of students and storing the uploaded files in the data storage unit. A selected one of the plurality of instructors can then access and review the uploaded files and provide instruction based on the uploaded files.

The system also includes means for receiving and storing in the data storage unit, a rating of the selected one of the plurality of instructors. The credentials provided by the instructor can include their rating.

The system also includes means for receiving payment from each of the plurality of students upon use of the system and means for distributing payment to the each of the plurality of instructors.

Instruction in a wide variety of sports can be provided. For example and without limitation, the sport can be selected from any of the following: golf, tennis, soccer, basketball, football, baseball, softball, men's lacrosse, women's lacrosse, skiing, snowboarding, water skiing, hockey, figure skating, gymnastics, fencing, racquetball, wrestling, Sumo wrestling, track and field events, cross country, swimming, diving, boxing, martial arts, volleyball, ping pong, bowling, rugby, cricket, polo, water polo, cycling, mountaineering and rock climbing, billiards, rowing, auto racing, motorcycle racing, surfing, weightlifting, squash, windsurfing, sailing, cheerleading and all Olympic events. Other sports can be provided as well. For example, dancing, ballet, archery, target shooting instruction can be provided as well.

In accordance with a preferred embodiment, instruction in multiple sports can be provided. In this case, each of the plurality of instructors specifies their sport and each of the plurality of students specifies their sport. In accordance with this aspect of the present invention, the student then selects the instructor with an additional criterion—the sport.

In accordance with another aspect of the present invention, the credentials of the instructors are selected from the group consisting of years experience teaching, years experience playing, articles, successes, availability, goals, location, occupation, resumes and combinations thereof. Other credentials can also be used. For example, the credentials can also include one or more ratings of the quality of an instructional experience. The location of the instructor can also be used as one of the selection criteria by a student.

In accordance with another aspect of the present invention, each of the plurality of instructors enters a price for instruction in the first data entry screen. The price is stored in the data storage unit and each of the plurality of students can select one of the plurality of instructors based on the price.

In accordance with another aspect of the present invention, an instructor may be selected automatically for a student using either predefined criteria, or criteria of the student's choosing. For example, the student's selection criteria may be for an instructor with the highest rating, but whose price is within a defined range. Alternatively the system may select the instructor using predefined criteria that the student has no control over.

In accordance with another aspect of the present invention, multiple instructors may be allowed to view the student request for instruction, and the first instructor that responds gets their business. In accordance with one aspect of the present invention, this operation is available at the option of the student.

In accordance with further aspects of the present invention, methods and systems are provided to allow any instructor and any student to sign up to provide or take lessons. The students can rate the instruction provided to allow future students to select instructors based on their popularity. Thus, the systems and methods in accordance with one aspect of the present invention provide an open marketplace of athletic instruction.

In accordance with another aspect of the present invention, systems and methods for providing video files of athletes in actions and other files describing the athlete's performance and questions are transmitted via a mobile phone to a server for review by an instructor. The instructor can provide the instruction back to the student's mobile phone. In one embodiment, the instruction is provided as soon as the student sends a video. Thus, a golfer who is continually slicing a ball during a round of golf can take a video clip with his or her mobile phone, send the video clip to the system of the present invention, and receive instruction and comments about his or her stroke while playing to try to correct the slice. In accordance with other aspects of the present invention, the mobile phone transmission can be by a web connection and a browser or by a non-browser technique.

The present invention also contemplates methods of providing online sports instruction, as described herein.

### DESCRIPTION OF THE DRAWINGS

FIG. 1 illustrates a system in accordance with one aspect of the present invention.

FIG. 2 illustrates a start up page in accordance with an aspect of the present invention.

FIG. 3 illustrates a sign in page in accordance with an aspect of the present invention.

FIG. 4 illustrates a submission page for students in accordance with an aspect of the present invention.

FIG. 5 illustrates an instructor selector page for use by students in accordance with an aspect of the present invention.

FIG. 6 illustrates an instructor information page for use by students in accordance with an aspect of the present invention.

FIG. 7 illustrates a media upload windows page for use by students in accordance with an aspect of the present invention.

FIG. 8 illustrates a page for use by students to view a history of usage as well as pending lessons that they have not yet viewed.

FIG. 9 illustrates an instructional page for use by students to view instructional lessons from an instructor, and for students to rate the quality of the lesson.

FIG. 10 illustrates a page for use by instructors in accordance with an aspect of the present invention to view old and new lessons.

FIG. 11 illustrates a page used by instructors to create lessons.

### DESCRIPTION OF A PREFERRED EMBODIMENT

One aspect of the present invention provides an open system and method for students and instructors in a variety of sports and at any location to connect so that the students can improve their performance. The students can upload a variety of media types showing how they perform and indicating questions and concerns. The students can select any of a number of instructors from anywhere in the world to receive lessons from. The instructors can download the appropriate files, view or listen to them and provide lessons. In accordance with another aspect of the present invention, the students can rate the instructors.

Thus, the present invention provides, among other things, an online system where any student of a sport can reach any instructor. Thus, for example, if a soccer player is interested in Brazil's “beautiful game” style of soccer, the soccer player can use the present invention to learn soccer from any number of Brazilian soccer players or instructors. As another example, if a student of a more esoteric sport is having trouble finding an instructor that the student connects with, then the student can use the present invention to find an instructor anywhere in the world.

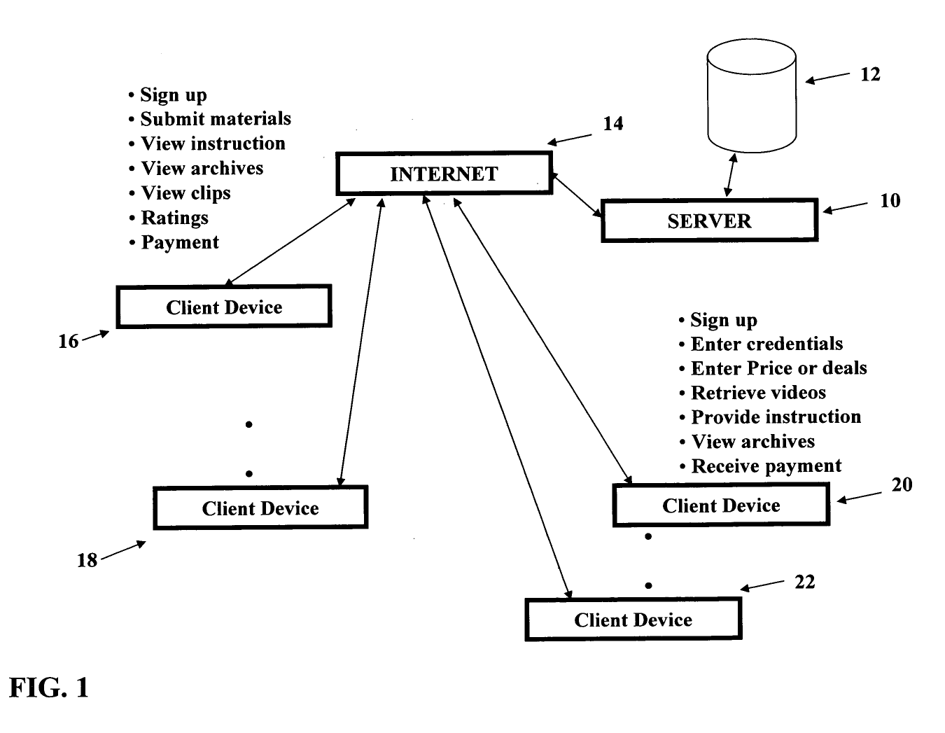

Referring to FIG. 1, a system and method in accordance with one aspect of the present invention is illustrated. A server 10 with a database 12 is connected to the internet 14. The server 10 includes a standard operating system, file system, web server, and e-commerce capabilities as well as applications and web services in accordance with the various aspects of the present invention. The database 12 can be any type of database or memory. It will hold the data records of instructors, students, media file references, and transaction data. Media data files are stored in the standard file system. Media types include, but are not limited to, text, video, image, and audio.

Devices 16 to 18 are also connected to the internet 14. Of course there are numerous devices 16 to 18 connected to the internet 14, but these devices preferably record, play video and transmit video files to the server. The devices 16 to 18 can be a personal computer with video files loaded onto it. They can also be mobile phones or PDAs (personal digital assistants) with video capabilities. In short, the devices 16 to 18 can be anything that records, plays and transmits video files, audio files, text files, other file types or a combination thereof over an internet 14 connection to a server 10.

The devices 16 to 18 may be a combination of devices. For example, a student may take a video with his mobile phone or video recorder and then send the files to the server 10 by a personal computer 16. Alternatively, video files could also be uploaded to the server directly by a mobile phone or PDA.

The devices 16 to 18 can also be, but are not necessarily, capable of providing the activities indicated in FIG. 1. These include signing up for the service, submitting materials to the server, viewing instructional clips, viewing archived instructional and video clips, rating instructors and making payments for the service. Of course, several devices may be used by a student or instructor. For example, a student can use a personal computer to establish an account and select an instructor, and use a mobile device, such as a mobile phone with the aforementioned video capabilities to record and transmit videos of the student in action to their PC, or directly to server 10. Similarly, an instructor can use different devices to establish an account and to provide instruction.

The devices 20 to 22 are also connected to the internet, and are preferably personal computers, PDA's, or mobile phones with video capability used by instructors to view the information provided by the students and to provide instruction. These devices 20 to 22 are preferably capable of providing sign on and sign up capabilities, allow an instructor to enter credentials, enter prices or other deals for the services, retrieve and view video files and other types of media files, provide instruction by creating files of different types, including video, audio, image and text files, selecting and viewing archived instructional and other video clips, and viewing billing and payment history.

Generally, the devices 20 to 22 are the same as the devices 16 to 18. As described before, they can include personal computers and other mobile devices that have video capabilities.

In general, the system is a ‘web service’ using the standard browsers and network protocols that are common to client devices such as 16 to 18 and 20 to 22. No custom software or hardware is needed for the students or instructors to use the system, although it may be used if desired. Everything runs over the web using standard HTTP (hyper text transfer protocol) methods, or any successor or similar protocols and methods.

The database 12 is preferably, but not necessarily, a SQL database. One embodiment has the following tables: USERS, STUDENTS, INSTRUCTORS, SPORTS, MEDIA, STUDENT_SPORTS, INSTRUCTOR_SPORTS, PAYMENTS, MEDIA_GROUPS, REVIEWS, and TRANSACTIONS.

The USERS table contains the basic information about all system users, and can include the fields: ID, USERNAME, PASSWORD, FIRST_NAME, LAST_NAME, EMAIL, PHONE, ADDRESS, and LANGUAGE.

The STUDENTS table provides additional information for student users, and can include the fields: STUDENT_ID, AGE, HEIGHT, WEIGHT, GOALS, and BILLING_INFORMATION.

The INSTRUCTORS table provides additional information for instructor users, and can include the fields: INSTRUCTOR_ID, AVG_RATING, TXT_RESUME_ID, and VID_RESUME_ID.

The SPORTS table provides an ID for each sport, and can include the fields: ID, and SPORT_NAME.

The MEDIA table tracks all uploaded media and can contain the fields: ID, FILENAME, TIMESTAMP, TYPE, SPORTS_ID, USERS_ID, PRICE, VIEWCOUNT, and STATUS.

The STUDENT_SPORTS table lists the various sports for each student and therefore can contain the fields: STUDENT_ID, SPORTS_ID, EXPERIENCE_LEVEL, and GOALS.

The INSTRUCTOR_SPORTS table lists the various sports for each instructor and therefore can contain the fields: INSTRUCTOR_ID, SPORTS_ID, YEARS_TEACHING, YEARS_PLAYING, PLAYING_LEVEL, AVG_RATING, RATING_COUNT, AVG_RESPONSE_TIME, and PRICE.

The PAYMENTS table tracks all payments made by students and can contain the fields: TIMESTAMP, STUDENT_ID, INSTRUCTOR_ID, MEDIA_ID, AMOUNT, TYPE, and STATUS.

The MEDIA_GROUPS table groups media files together to represent an instructor's lesson or student's request and can contain the fields: ID and MEDIA_ID.

The REVIEWS table describes the reviews given by students to instructors and/or lessons provided by instructors and can contain the fields: TIMESTAMP, STUDENT_ID, INSTRUCTOR_ID, SPORT_ID, SUBJECT_MEDIA_GROUP_ID, RATING, and REVIEW_MEDIA_GROUP_ID.

The TRANSACTIONS table lists the transactions of media between students and instructors, and can contain the fields: ID, TIMESTAMP, STUDENT_ID, INSTRUCTOR_ID, MEDIA_GROUP_ID, PAYMENT_ID, TYPE, and STATUS.

In the foregoing, STUDENT_ID and INSTRUCTOR_ID refer back to the ID field in the USERS table. Similarly, TXT_RESUME_ID, VID_RESUME_ID refer to the ID field in the MEDIA table. SPORTS_ID, MEDIA_ID, PAYMENTS_ID, MEDIA_GROUP_ID and REVIEW_MEDIA_GROUP_ID refer to the ID field of those tables.

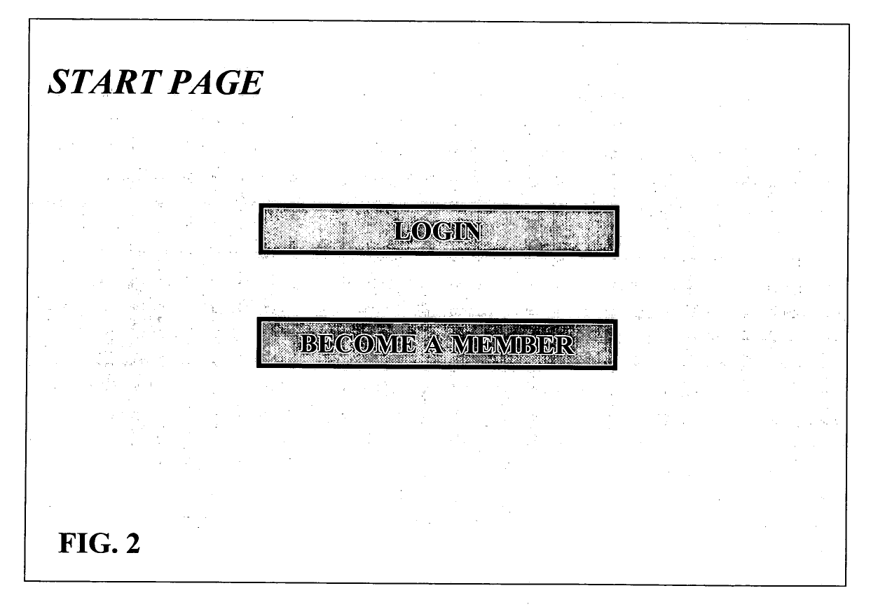

Various pages useful in the present invention are illustrated in FIGS. 2 to 11. These pages merely illustrate one embodiment of the present invention assuming a common web browser is used for accessing this service as a set of web pages on an internet website. The use of the term ‘web page’ or ‘page’ is not meant to mean that this invention is restricted to browsing of web pages on the internet, rather this is a common and convenient embodiment to describe the present invention. Other forms of graphical user interfaces, windows, and screens may be used to provide the desired functionality as appropriate for the client device. For example, if a PDA or mobile phone with a small screen size is used as device 16, or 18, or 20, or 22, then the page information may be better organized as a larger number of smaller WAP pages or application screens to provide similar functionality. Similarly, any number of different pages can be used to implement the various aspects of the present invention. In short, one aspect of the present invention is preferably a web service that is client device agnostic with respect to the human interface, provided the client device has the requisite standard web browser functionality. This allows easier implementation of the present invention.

FIG. 2 illustrates a start up page in accordance with an aspect of the present invention. The page of FIG. 2 provides several choices. A first command button with the label LOGIN is provided. This allows a student or instructor to sign in. A second command button with the label BECOME A MEMBER is provided. This button allows a person to join a peer-to-peer network in accordance with one aspect of the present invention.

When the BECOME A MEMBER command button is selected, a prompt is provided to indicate whether the user is a student or an instructor. If the user is a student, then the page asks for the first and last names of the student, a username so that the actual identity of the student can be protected, and the student's goals. The student goals may be important to an instructor. For example, if a student is seeking to become a ranked tennis player, the instruction provided may be different than if a recreational player is seeking instruction. Student information is stored in the USERS, STUDENTS, and STUDENT_SPORTS tables.

If the new user is an instructor, then a page will ask for the first and last name of the instructor, the price for their services, and other credentials. The other credentials include years teaching experience, years playing experience, level of play, location. The credentials can also include publications and success stories with other students. The credentials can also include the ratings and other testimonials provided by students. For example, the ratings provided by students can be averaged and displayed to prospective students. The instructor's information is stored in the USERS, INSTRUCTORS, and INSTRUCTOR_SPORTS tables.

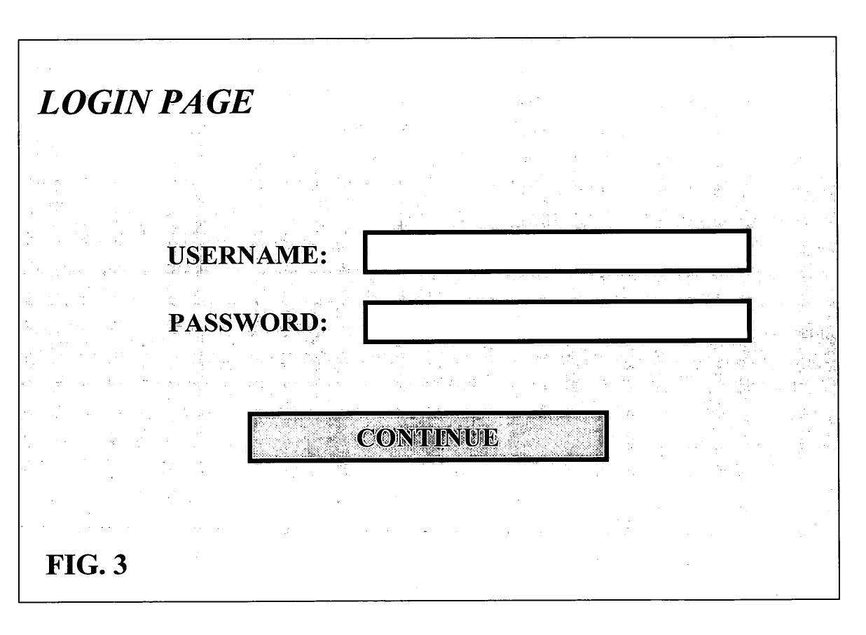

FIG. 3 illustrates a login page in accordance with an aspect of the present invention. This page can be used any time a student or an instructor signs in. It asks for their username and password. When the CONTINUE command button is selected, then the username and password are compared to the information in the USERS table and entry into the system is granted or not granted depending on the result.

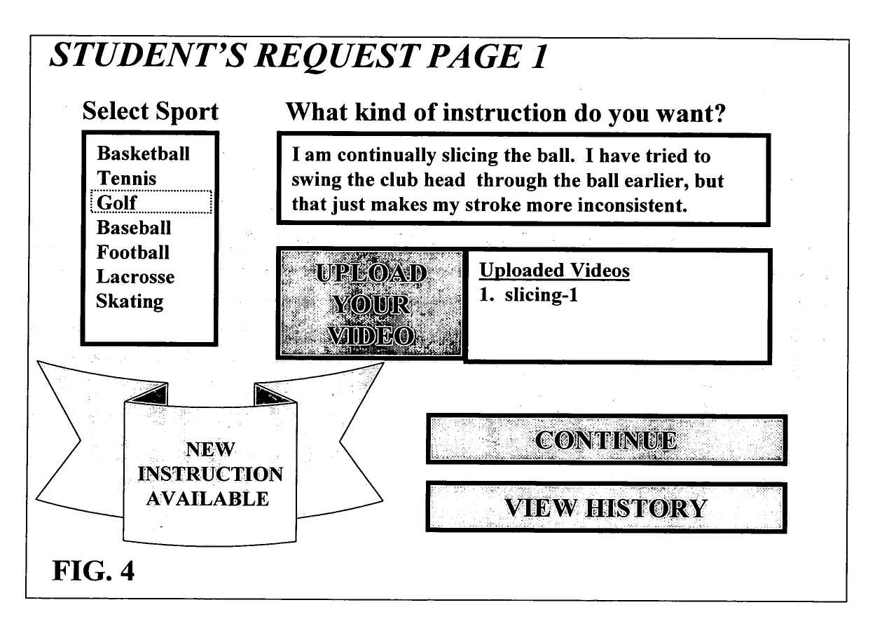

FIG. 4 illustrates a submission page for students in accordance with an aspect of the present invention. This page is preferably displayed after a successful sign in by a student. If the student has indicated they are interested in multiple sports when he or she became a member, the drop down list with the sports the student is interested in is displayed. This can be determined by searching the STUDENT_SPORTS table. If there is only one sport, then the drop down list does not need to be displayed. Further, the instructions available for all sports can be displayed in future pages, in which case, the drop down list is also not needed.

FIG. 4. includes a text input box where the student can describe the instructions that are wanted.

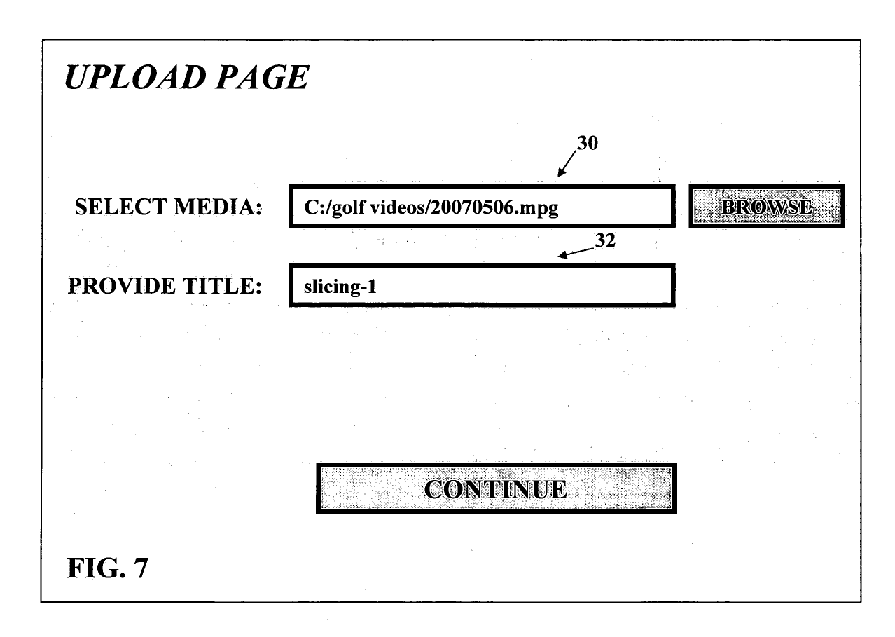

FIG. 4. also includes a command button labeled UPLOAD YOUR VIDEO. Clicking on this command button will allow the student to upload submit one or more videos for an instructor to view. FIG. 7 shows an example page that would open to enable the student to upload a video. Non-video files may also be uploaded, such as audio or still pictures. Additional media files may be uploaded by repeating this process. All uploaded media is stored in the server file system and tracked in the MEDIA table.

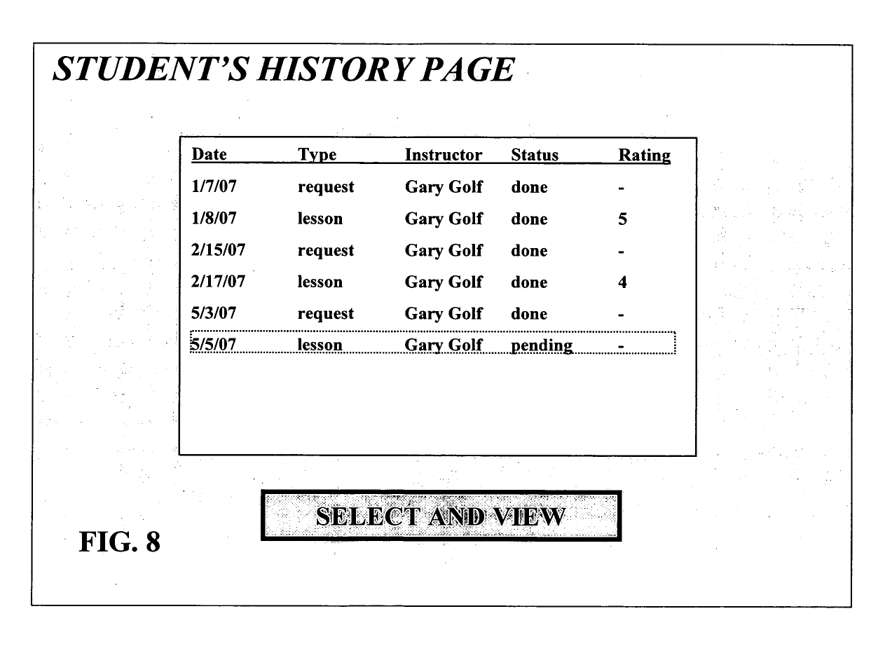

FIG. 4. includes a command button labeled VIEW HISTORY. This allows the student to view a list of videos submitted and lessons received. Clicking on this command button preferably opens the page of FIG. 8. The history of student and instructor activity is tracked in the TRANSACTIONS table.

A banner is also shown in FIG. 4. that states NEW INSTRUCTION AVAILABLE. In this case, the banner indicates that an instructor has responded. A student may then click on the VIEW HISTORY command button, which will then open the page shown on FIG. 8. Where there is no lesson available, the banner states NO INSTRUCTION AVAILABLE. The system finds these new pending lessons by searching the TRANSACTIONS table for any records with TYPE equal to “lesson” and STATUS equal to “pending”, and the appropriate STUDENT_ID and SPORTS_ID. The MEDIA_GROUP_ID for all such records identify the pending lesson material available for the student.

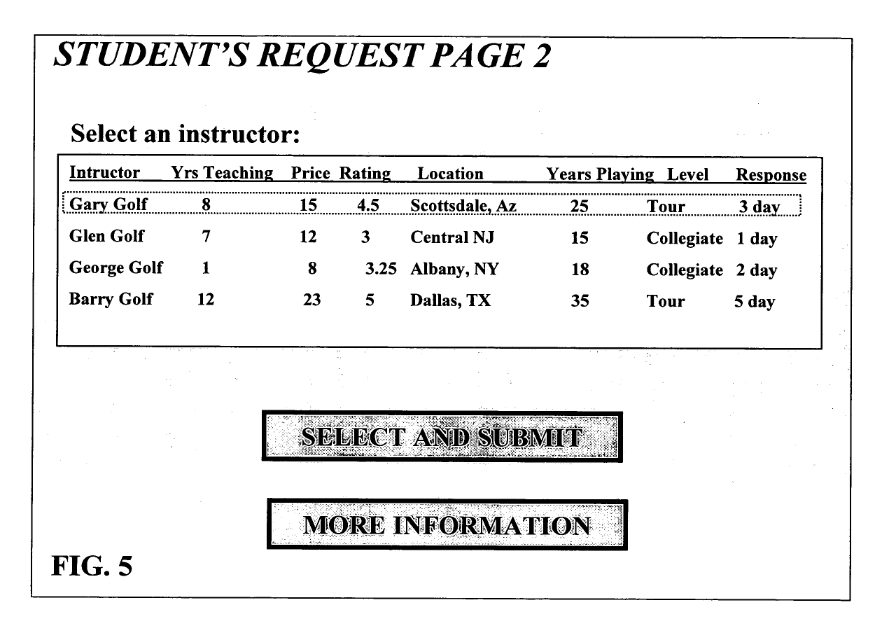

FIG. 5 illustrates an instructor selector page for use by students in accordance with an aspect of the present invention. This page is displayed when the CONTINUE command button in FIG. 4 is selected.

FIG. 5 includes a list of instructors and their credentials, by sport. The list is generated by reading the INSTRUCTOR_SPORTS table referencing the appropriate SPORTS_ID. The associated INSTRUCTOR_ID can be used to locate more information for the instructors from the other database tables. In this case, instructors from a single sport are listed. In other embodiments of the present invention, instructors from multiple sports can be listed, or only instructors matching predefined or student defined criteria may be listed. The list can be sorted by the credentials. For example, clicking on years teaching experience will sort the instructors by that criterion.

The credentials shown include years, teaching, price, an average rating by students, a location, years playing and level of play. An availability is also indicated. In this case, the availability is determined by the average time the instructor has historically taken to respond to student requests for instruction. All of this information is determined from the information entered by an instructor when he or she becomes a member, and in the information acquired as the system is used.

Instructors are individually selected by clicking on their name, which will result in visual highlighting of their row. Once an instructor has been selected by highlighting their row on FIG. 5, they may either be selected, or more information about them may be had.

Instructors are selected to provide instruction by clicking the SELECT AND SUBMIT command button. One or more records are then added to the MEDIA and MEDIA_GROUPS tables referencing each media file uploaded and grouping them together using a MEDIA_GROUP_ID. A single record is then added to the TRANSACTIONS table with the TYPE field set equal to “request”, the MEDIA_GROUP_ID field set equal to the ID of the group created in the previous step, the STATUS field set equal to “pending” and other fields filled in as appropriate for this student's request.

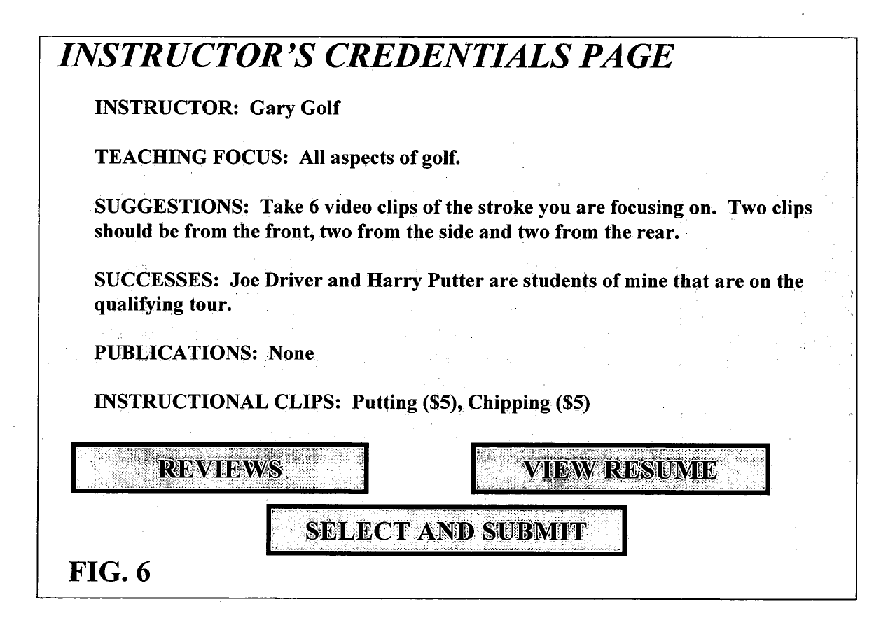

More information about a selected instructor can be determined by clicking the MORE INFORMATION command button. In accordance with one embodiment of the present invention, this is provided by opening the page of FIG. 6.

In FIG. 6, a student can view the instructor's description of his or her teaching focus, suggestions in how to improve the process and descriptions of the instructor's successes. This description can be a summary portion of the instructor's resume that is found in the MEDIA table via the TXT_RESUME_ID in the INSTRUCTORS table.

The full instructors resume could be viewed by clicking on the RESUME command button on FIG. 6. Other information that is available about the instructors can also preferably be viewed.

By clicking on the REVIEWS command button of FIG. 6, a prospective student can view reviews and ratings provided by other students of the instructor. The system finds this information by searching the REVIEWS table for any records that contain the appropriate INSTRUCTOR_ID. The REVIEW_MEDIA_GROUP_ID for any such records identify the review record(s) in the MEDIA table.

Clicking on the SELECT AND SUBMIT command button on FIG. 6 results in the student's request for instruction being made available for instructor review, as previously described.

FIG. 7 illustrates a media upload page for use by students or instructors in accordance with an aspect of the present invention. For students, after taking one or more video clips of the student in action, the student stores the video and then causes the video to be sent to the server 10 and database 12. The student can either type in the full path name of the video clip in the box 30, or the student can select the BROWSE command button next to the box 30 to select the video file using a standard file browser.

The student can also provide a title for the media file by typing the title into box 32.

When the student clicks the CONTINUE command button, the device 16 or 18 causes the information to be sent to the server 10 over the internet 14. When the server 10 receives the information, it stores the information in the database 12, and updates the MEDIA, MEDIA_GROUPS, and TRANSACTIONS tables described above.

FIG. 8 illustrates a page for use by students to view a history of usage as well as pending lessons. This page is opened when the VIEW HISTORY command button in FIG. 4 is selected. The list includes the date of requests for instruction, the selected instructor's name, and indicates whether the instructor has provided instruction. This also shows ratings the student has previously provided. The server retrieves this information from the database by searching the TRANSACTIONS table for records that contain the STUDENT_ID and TYPE field equal to “request” or “lesson”.

A student can view an old request or lesson by highlighting it and clicking the SELECT command button. Alternatively, the student can view a new lesson in the same manner. Thus, if the student wanted to see the new ‘pending’ lesson from May 5, 2007, the student would highlight that line and click the SELECT AND VIEW command button.

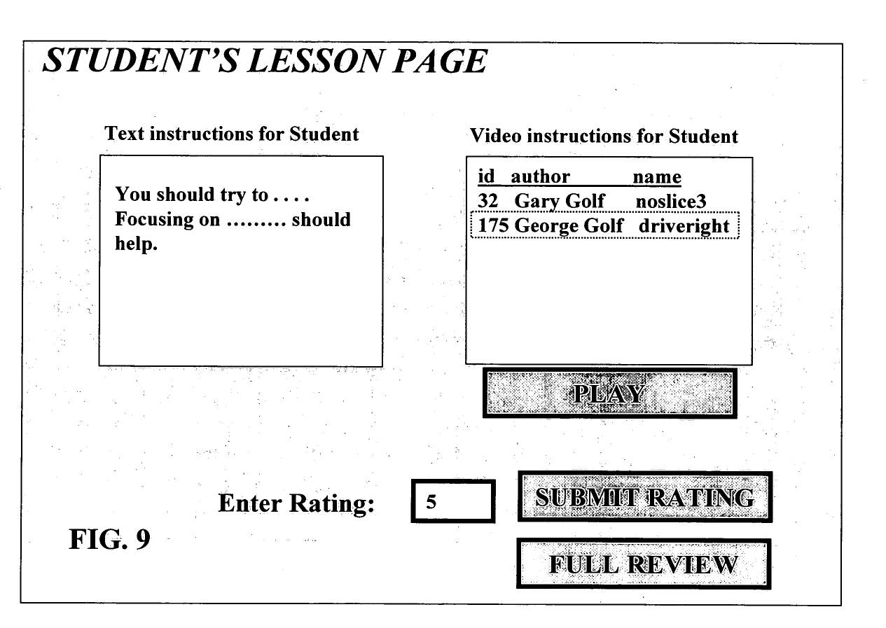

FIG. 9 illustrates a page for use by students to view lessons from an instructor. This page opens when a lesson is selected on the page of FIG. 8. The system automatically reads the MEDIA table to get the filenames for the selected lesson and makes them available for viewing on this STUDENT LESSON PAGE. These media files have been created or selected by the instructor and can be found automatically by the system by searching the MEDIA_GROUPS table for all records that contain the MEDIA_GROUP_ID of the selected lesson. The MEDIA_ID fields of these records identify all lesson material. Text media files can be concatenated together in the text instruction box on the left, and each media file (video or audio or picture) is listed in the box on the right. The student plays a media file by first selecting it, and then clicking the PLAY command button. The appropriate media player then opens and plays the media. The student then tries to implement the instructions in his or her game.

A rating box is also provided in FIG. 9. A student can rate the lesson at that time by entering a number, preferably from 1 to 5 in the box and clicking the SUBMIT RATING command button.

Additionally, a student can click the provided FULL REVIEW command button, which causes the upload page shown in FIG. 7 to be displayed. This allows the student to upload media and/or enter text which will be displayed in the REVIEWS section of the instructor's credentials page shown in FIG. 6.

Once the SUBMIT RATING command button is clicked, the rating number will be stored in the REVIEWS table for the record associated with that lesson, and also used to update the AVG_RATING field in the INSTRUCTOR_SPORTS table for the instructor. If the student provided media for a review, a reference to it is stored in the REVIEW_MEDIA_GROUP_ID field. Finally, the STATUS field of the record in the TRANSACTIONS table associated with this lesson is set equal to ‘done’.

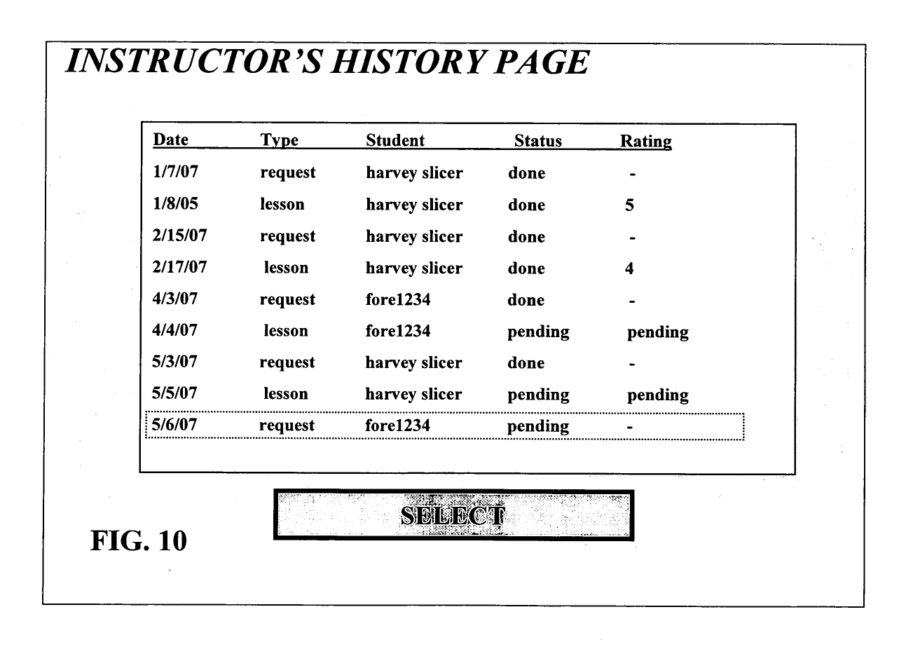

FIG. 10 illustrates a page for use by instructors in accordance with an aspect of the present invention to view old and new lessons. This page is preferably displayed after a successful login by an instructor. The page includes a table that lists a history of student requests for instruction, and the lessons provided by the instructor, as well as those lessons to be provided. It includes the date, the type which is either a student ‘request’ or an instructor's ‘lesson’, the student username, the status, and the student rating of the lesson. As shown the status can be ‘pending’ if not yet viewed or acted on by the recipient, or ‘done’ if the instructor has completed a lesson response, or if the student has viewed the lesson.

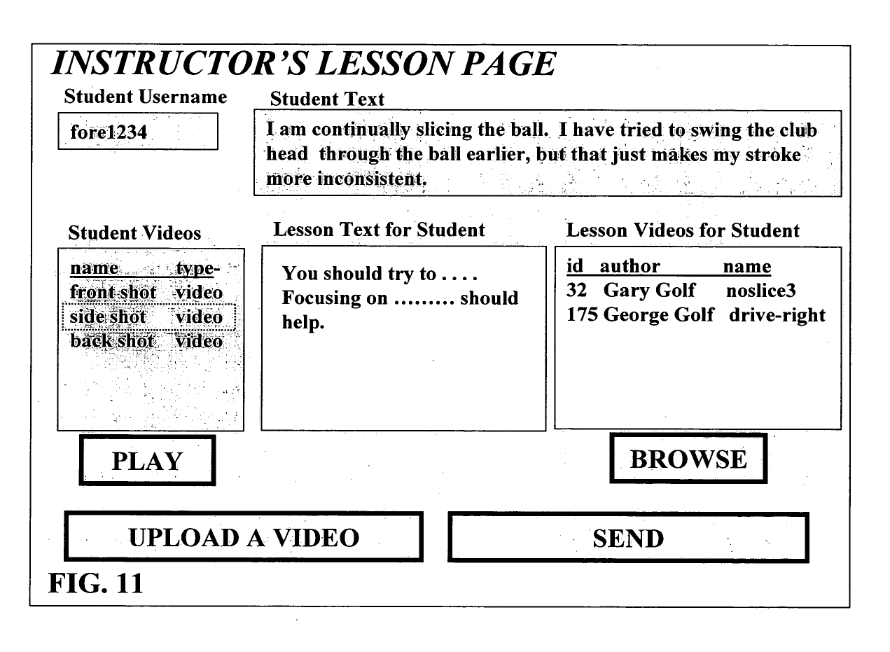

An instructor can view old lessons by highlighting a lesson that has a ‘done’ status and clicking the SELECT command button. Alternatively, an instructor can create a new lesson by highlighting a request with ‘pending’ status and clicking the SELECT command button. Doing so will open the INSTRUCTOR LESSON PAGE shown on FIG. 11. Although not shown, the list of FIG. 10 can include a due date to indicate when the response to the student's submission is due.

FIG. 11 illustrates a page used by instructors to provide lessons. This page is preferably opened when an instructor selects a pending student request line in FIG. 10. The page of FIG. 11 shows the student username, the text message from the student, and lists all media files the student has uploaded with their request. These media files are preferably video, but can also include audio and still pictures, or other media as allowed by the upload page shown on FIG. 7. These media files, including the text, are identified automatically by the system using the MEDIA_IDs found by searching the MEDIA_GROUPS table for all records that contain the MEDIA_GROUP_ID of the selected request. The instructor can play any media file by selecting it and clicking the PLAY command button. This will open the appropriate media player. After reviewing the student text and viewing the video clips, the instructor can create a response by typing a text response to the student, and by adding video clips to the lesson. Typically the instructor will look for existing video instructional clips on the server by clicking on the BROWSE command button which opens a file browser to allow easy selection of the online video clip library. Alternatively the instructor may wish to upload a new video clip for the student. Clicking on the UPLOAD VIDEO command button opens the upload page shown on FIG. 7. This operation works as previously described for students. The appropriate tables in the database 12 will be updated.

The devices 20 to 22 preferably include a video camera and microphone to allow the instructor to easily create new instructional video clips. It is anticipated that instructional video clips may be shared by multiple instructors. It is further anticipated that instructors may be compensated for the use of the instructional video clips they have created.

When the instructor is satisfied with the lesson he can click the SEND command button. This will enter all text, video, and other media records into the database in the same manner as described for student requests above, but with the TYPE field set to ‘lesson’. Further, the record associated with the student's request in the TRANSACTIONS table will have its STATUS field set equal to ‘done’. The student can be informed of the available instruction as previously described with a banner or with any other form of communication, including but not limited to, an email or a text message.

As previously mentioned, the devices 16 to 18 used by students can be personal computers, mobile phones or any other device or combination of devices that has video and data transmission capabilities. In accordance with another aspect of the present invention, systems and methods for providing video files of athletes in actions and other files describing the athlete's performance and questions are transmitted via a mobile phone to a server for review by an instructor. The instructor can provide the instruction back to the student's mobile phone. In one embodiment, the instruction is provided as soon as the student sends a video. Thus, a golfer who is continually slicing a ball during a round of golf can take a video clip with his or her mobile phone, send the video clip to the system of the present invention, and receive instruction and comments about his or her stroke while playing to try to correct the slice. In accordance with other aspects of the present invention, the mobile phone transmission can be by a web connection and a browser or by a non-browser technique.

One or more embodiments of the system and method of the present invention are described in this specification. Other embodiments within the boundaries of the present invention, however, are contemplated by the present specification and claims.

1. A system for providing instruction in a sport over the internet, comprising:
a data storage unit that stores information relating to a plurality of instructors in the sport and to a plurality of students in the sport;
a first data entry page used by the plurality of instructors, wherein each of the plurality of instructors can enter a name and one or more credentials into the data storage unit;
a second data entry page used by the plurality of students to select one of the plurality of instructors based on the one or more credentials;
means for receiving one or more files from one of the plurality of students and storing the files in the data storage unit and for having a selected one of the plurality of instructors reviewing the files and providing instruction based on the files.

2. The system of claim 1, wherein the files are selected from the group consisting of text files, audio files, picture files, video files and combinations thereof.

3. The system of claim 1, further comprising means for receiving and storing in the data storage unit, a rating of the selected one of the plurality of instructors.

4. The system of claim 3, wherein the one or more credentials includes the rating.

5. The system of claim 1, further comprising means for receiving payment from each of the plurality of students upon use of the system.

6. The system of claim 5, further comprising means for distributing payment to the each of the plurality of instructors.

7. The system of claim 1, wherein the sport is selected from the group consisting of golf, tennis, soccer, basketball, football, baseball, softball, men's lacrosse, women's lacrosse, skiing, snowboarding, water skiing, hockey, figure skating, gymnastics, fencing, racquetball, wrestling, Sumo wrestling, track and field events, cross country, swimming, diving, boxing, martial arts, volleyball, ping pong, bowling, rugby, cricket, polo, water polo, cycling, mountaineering and rock climbing, billiards, rowing, auto racing, motorcycle racing, surfing, weightlifting, squash, windsurfing, sailing, cheerleading, all Olympic events, dancing, ballet, archery, and target shooting.

8. The system of claim 1, the sport includes multiple sports and each of the plurality of instructors specifies their sport and each of the plurality of students specifies their sport.

9. The system of claim 1, wherein the credentials are selected from the group consisting of years experience teaching, years experience playing, articles, successes, availability, goals, location, occupation, resumes and combinations thereof.

10. The system of claim 9, wherein the credentials include one or more ratings of the quality of an instructional experience.

11. The system of claim 1, wherein each of the plurality of instructors enters a price for instruction in the first data entry screen, the price being stored in the data storage unit, and wherein each of the plurality of students can select one of the plurality of instructors based on the price.

12. The system of claim 1, further comprising a third data entry page used by the plurality student to enter information about themselves into the data storage unit.

13. A method for providing instruction in a sport over the internet, comprising:
each of a plurality of instructors entering a name and one or more credentials into a server based data storage unit;
each of the plurality of students selecting one of the plurality of instructors based on the one or more credentials; and
at a server, receiving one or more uploaded files from each of the plurality of students and storing the uploaded files in the data storage unit, a selected one of the plurality of instructors reviewing the uploaded files and providing instruction based on the uploaded files.

14. The method of claim 13, further comprising rating the selected one of the plurality of instructors.

15. The method of claim 14, wherein the one or more credentials includes the rating.

16. The method of claim 13, further comprising receiving a payment from each of the plurality of students.

17. The method of claim 16, further comprising distributing payment to the each of the plurality of instructors based upon student usage.

18. The method of claim 13, wherein the sport is selected from the group consisting of golf, tennis, soccer, basketball, football, baseball, softball, men's lacrosse, women's lacrosse, skiing, snowboarding, water skiing, hockey, figure skating, gymnastics, fencing, racquetball, wrestling, Sumo wrestling, track and field events, cross country, swimming, diving, boxing, martial arts, volleyball, ping pong, bowling, rugby, cricket, polo, water polo, cycling, mountaineering and rock climbing, billiards, rowing, auto racing, motorcycle racing, surfing, weightlifting, squash, windsurfing, sailing, cheerleading, all Olympic events, dancing, ballet, archery, and target shooting.

19. The method of claim 13, the sport includes multiple sports and each of the plurality of instructors specifies their sport and each of the plurality of students specifies their sport.

20. The method of claim 19, wherein the sports are selected from the group consisting of: golf, tennis, soccer, basketball, football, baseball, softball, men's lacrosse, women's lacrosse, skiing, snowboarding, water skiing, hockey, figure skating, gymnastics, fencing, racquetball, wrestling, Sumo wrestling, track and field events, cross country, swimming, diving, boxing, martial arts, volleyball, ping pong, bowling, rugby, cricket, polo, water polo, cycling, mountaineering and rock climbing, billiards, rowing, auto racing, motorcycle racing, surfing, weightlifting, squash, windsurfing, sailing, cheerleading, all Olympic events, dancing, ballet, archery, and target shooting.

21. The method of claim 13, wherein the credentials are selected from the group consisting of years experience teaching, years experience playing, articles, successes, availability, goals, location, occupation, resumes and combinations thereof.

22. The method of claim 21, wherein the credentials include one or more ratings of the quality of an instructional experience.

23. The method of claim 13, wherein each of the plurality of instructors enters a price for instruction in the first data entry page, the price being stored in the data storage unit, and wherein each of the plurality of students can select one of the plurality of instructors based on the price.
